(19) United States
(12) Patent Application Publication
(10) Pub. No.: US 2009/0110811 A1
(43) Pub. Date: Apr. 30, 2009

(54) Method of improving the thermal stability of electrically conductive polymer films

(75) Inventors: Yiwei Ding, Ballwin, MO (US); Scott Hayes, Arnold, MO (US); Jill C. Simpson, Clayton, MO (US)

Correspondence Address: NELSON MULLINS RILEY & SCARBOROUGH, LLP, 1320 MAIN STREET, 17TH FLOOR, COLUMBIA, SC, 29201, US

(73) Assignee: Lumimove, Inc. dba CROSSLINK, St. Louis, MO (US)

(21) Appl. No.: 11/977,184

(22) Filed: Oct. 24, 2007

(51) Int. Cl. B05D 5/12; H01B 1/00; H01G 9/022

(52) U.S. Cl. 427/80; 252/500; 427/58

(57) ABSTRACT

A method of making an electrically conductive polymer film having improved thermal stability is described where the method comprises providing a film of an electrically conductive polymer having as a dopant a first protonic acid that is selected to solubilize the doped conductive polymer in a first organic solvent, and contacting the film with a mixture of a second organic solvent and a second protonic acid.

### BACKGROUND OF THE INVENTION

The present invention relates to a method of improving the thermal stability of a conductive polymer film, and more particularly to a method of improving the thermal stability of a doped conductive polymer film that has been applied from an organic solvent.

Intrinsically conductive polymers such as polyaniline, polythiophene, polypyrrole, and the like, are used as electrically conductive elements in many applications. Recently, conductive polymer films have been reported for use as cathodes in valve-metal capacitors. Conductive polymer film electrodes are described for use in tantalum capacitors in U.S. Pat. Nos. 7,271,994 and 7,233,484, in aluminum capacitors in U.S. Pat. No. 7,215,534, and in niobium capacitors in U.S. Pat. Nos. 7,274,552, 7,236,350, among many others.

In some instances, conductive polymer film electrodes have been reported to be degraded or to change properties during thermal stress, such as when a capacitor is soldered onto a circuit board or during reflow soldering treatment. These changes can include one or more of an increase in the equivalent series resistance (ESR), a decrease in capacitance, an increase in shorts, and/or an increase in leakage current.

In U.S. Pat. No. 7,265,965, the inventors reported a reduction in ESR shift in capacitors having adjacent doped conductive polymer layer and carbon layer by adding dopant to the carbon layer. In U.S. Pat. No. 7,262,954 it was reported that ESR shift was reduced by inserting a layer of propylene glycol between the valve-metal oxide dielectric layer and the conductive polymer electrode layer. Another approach, reported in U.S. Pat. No. 6,982,865, claims a dopant combination of water soluble acid anions tetrahydronaphthalenesulfonate and either naphthalenesulfonate or benzenesulfonate for increased heat resistance and low ESR. U.S. Pat. No. 6,912,118 describes a capacitor having a solid electrolyte layer containing a conductive polymer that contains at least a fluoroalkylnaphthalenesulfonic acid as a dopant, but which can further contain tetrahydronaphthalenesulfonate or benzenesulfonate or naphthalenesulfonate as dopant, and describes the material as providing low ESR and good heat resistance.

### SUMMARY OF THE INVENTION

Briefly, therefore, the present invention is directed to a novel method of making an electrically conductive polymer film having improved thermal stability, the method comprising, providing a film of an electrically conductive polymer having as a dopant a first protonic acid that is selected to solubilize the doped conductive polymer in a first organic solvent, and contacting the film with a mixture of a second organic solvent and a second protonic acid.

The present invention is also directed to a novel method of using an electrically conductive polymer film having improved thermal properties as a solid electrolyte in a valve-metal capacitor, the method comprising, providing a capacitor body comprising an anode of the valve-metal, a dielectric metal oxide layer, and an electrically conductive polymer film cathode having a thermal stability and which comprises a conductive polymer having as a dopant a sufficient amount of a first protonic acid that is selected to solubilize the conductive polymer in a first organic solvent, and contacting the film with a second organic solvent containing a second protonic acid.

The present invention is also directed to a novel method of making an electrically conductive polymer film having improved thermal stability, the method comprising, providing a film of an electrically conductive polymer having as a dopant a first protonic acid that is selected to solubilize the doped conductive polymer in a first organic solvent, and contacting the film with a mixture of a second organic solvent and a second protonic acid, wherein the concentration of the second protonic acid in the mixture with the second organic solvent and the time of contacting are selected to provide a Δ-ESR that is less than about 5 mΩ when the film is subjected to a temperature of 260° C. for 15 seconds.

### BRIEF DESCRIPTION OF THE DRAWINGS

FIG. 1 shows electrical conductivities of films of polyaniline doped with dinonylnaphthalene sulfonic acid (PANi/DNNSA films) treated with various organic solvents or solvent mixtures including butylcellosolve (BC), isopropanol (iPrOH), n-butanol (nBuOH), and methanol (MeOH);

FIG. 2 shows the thicknesses of PANi/DNNSA films treated with various organic solvents or solvent mixtures including butylcellosolve (BC), isopropanol (iPrOH), n-butanol (nBuOH), and methanol (MeOH);

FIG. 3 shows the results of isothermal thermogravimetric analysis (TGA) at 200° C. of an untreated PANi/DNNSA film and a PANi/DNNSA film treated with n-butanol (nBuOH) and indicates that the solvent-treated film is significantly more thermally stable than the untreated film;

FIG. 4 shows the electrical conductivities of four PANi/DNNSA films, each prepared in the same way, before and after treatment with a 5 wt % solution of p-toluenesulfonic acid (PTSA) in butylcellosolve (BC);

FIG. 5 shows the thicknesses of four PANi/DNNSA films before and after treatment with a 5 wt % solution of p-toluenesulfonic acid (PTSA) in butylcellosolve (BC);

FIG. 6 shows the results of isothermal thermogravimetric analysis (TGA) at 200° C. of an untreated PANi/DNNSA film and a PANi/DNNSA film treated with a 5 wt % solution of p-toluenesulfonic acid (PTSA) in butylcellosolve and shows that the PTSA-treated film was significantly more thermally stable than the untreated film;

FIG. 7 shows pre- and post-treatment film thicknesses of films of polyaniline doped with dinonylnaphthalenesulfonic acid with added 4,4′-sulfonyldiphenol (PANi/DNNSA-SDP films) treated with various solvents including butylcellosolve (BC), isopropanol (iPrOH), n-butanol (nBuOH), and methanol (MeOH) for 30 seconds unless otherwise indicated;

FIG. 8 shows pre- and post-treatment film conductivities of PANi/DNNSA-SDP films that were soaked in various solvents including butylcellosolve (BC), isopropanol (iPrOH), n-butanol (nBuOH), and methanol (MeOH) for 30 seconds unless otherwise indicated. Conductivities were calculated from surface resistance and film thickness in FIG. 7 using the following equation: σ=1/SR*d, where SR is the surface resistivity and d is the film thickness;

FIG. 9 shows the results of two-hour isothermal thermogravimetric analysis (TGA) of untreated PANi/DNNSA-SDP films at various temperatures. It is to be noted that the initial weight loss of ˜10% for each sample is attributable to residual solvents;

FIG. 10 shows the results of five-hour isothermal TGA of untreated PANi/DNNSA-SDP films at 150° C. or 170° C. It is to be noted that the initial weight loss of ˜10% is attributable to residual solvents;

FIG. 11 shows the results of a two-hour, 200° C. isothermal TGA scan of PANi/DNNSA-SDP film untreated and treated with solvents: 3:1 butylcellosolve-methanol (BC/MeOH), isopropanol (iPrOH), n-butanol (nBuOH), and xylenes;

FIG. 12 is a bar graph that shows the effect of acid treatment on PANi/DNNSA-SDP film thickness and indicates that treatment with p-toluenesulfonic acid (PTSA) or 4-sulfophthalic acid (4-SPHA) in either butylcellosolve (BC) or n-butanol (nBuOH), as noted, reduces the film thicknesses by more than half;

FIG. 13 is a bar graph showing the effect of acid treatment with either p-toluenesulfonic acid (PTSA) or 4-sulfophthalic acid (4-SPHA) in either butylcellosolve (BC) or n-butanol (nBuOH), as noted, on PANi/DNNSA-SDP film conductivity;

FIG. 14 shows UV-Vis spectra for PANi/DNNSA-SDP films before and after treatment with a 5 wt % solution of p-toluenesulfonic acid in butylcellosolve. The intensification of the free carrier tail between 500 nm and 1100 nm is evidence of the increase in film conductivity;

FIG. 15 shows the results of isothermal, 200° C. thermogravimetric analysis (TGA) of PANi/DNNSA-SDP film treated with a wt % solution of p-toluenesulfonic acid (PTSA) in butylcellosolve (BC) compared to the TGA scan of an untreated film;

FIG. 16 shows pre- and post-treatment conductivity for PANi/DNNSA-SDP films treated with p-toluenesulfonic acid (PTSA) solutions in butylcellosolve (BC) of different concentrations;

FIG. 17 is a graph showing post-treatment PANi/DNNSA-SDP film conductivity for different concentrations of PTSA in the BC treatment solution;

FIG. 18 shows the effect of the type of acid used in a 5% by wt. solution in butylcellosolve (BC) on electrical conductivity of PANi/DNNSA-SDP films, where PTSA=p-toluenesulfonic acid, BA=benzenesulfonic acid, CSA=camphorsulfonic acid, PA=phenylphosphonic acid, and H₃PO₄=phosphoric acid;

FIG. 19 shows the effect on electrical conductivity of PANi/DNNSA-SDP films of the time the film spent in contact with an acid/organic solvent solution comprising 5 wt % solutions of either phenylphosphonic acid (PA) or benzenesulfonic acid (BA) in butylcellosolve (BC) for either 15 or 30 seconds;

FIG. 20 shows the effect of treatment with aqueous buffer solutions of different pH levels for 30 minutes at 45° C. on the electrical conductivity of PANi/DNNSA-SDP films compared with the conductivity of an untreated PANi/DNNSA-SDP film (Control);

FIG. 21 shows the effect of treatment with various acids in 5 wt % aqueous solutions on the electrical conductivity of PANi/DNNSA-SDP films, where DBSA=dodecylbenzenesulfonic acid, 4-SPHA=4-sulfophthalic acid, PSSA=poly(styrenesulfonic acid), and PTSA=p-toluenesulfonic acid;

FIG. 22 shows the effect of treatment with 5 wt % aqueous acid solutions in the film thickness of PANi/DNNSA-SDP films, where DBSA=dodecylbenzenesulfonic acid, 4-SPHA=4-sulfophthalic acid, PSSA=poly(styrenesulfonic acid), and PTSA=p-toluenesulfonic acid;

FIG. 23 is a graph showing equivalent series resistance (ESR) of 470-μF, 2.5-V tantalum capacitors as a function of time at 200° C. for control anodes with internal and external non-polyaniline inherently conductive polymer (ICP) coatings, anodes coated with internal non-polyaniline ICP coatings and external PANi/DNNSA-SDP films with no p-toluenesulfonic acid (PTSA) treatment, and anodes coated with internal non-polyaniline ICP coatings and external PANi/DNNSA-SDP films having a 5 wt % PTSA treatment in either butylcellosolve (BC) or n-butanol (nBuOH). Anodes with internal non-polyaniline ICP coatings and external PANi/DNNSA-SDP films but without the additional PTSA treatment have ESR values of ˜80 mΩ after 2 hours at 200° C.;

FIG. 24 is a graph showing the shift in equivalent series resistance (Δ-ESR, the difference between the final ESR value and the initial ESR) of 470-μF, 2.5-V tantalum capacitors as a function of time at 200° C. for capacitors having control anodes with internal and external non-polyaniline inherently conductive polymer (ICP) coatings, anodes coated with internal non-polyaniline ICP coatings and external PANi/DNNSA-SDP films with no p-toluenesulfonic acid (PTSA) treatment, and anodes coated with internal non-polyaniline ICP coatings and external PANi/DNNSA-SDP films with PTSA treatment in either butylcellosolve (BC) or n-butanol (nBuOH). Also plotted are data for anodes treated with a 5% 4-sulfophthalic (SPHA) solution in BC, and two coatings of PANi/DNNSA-SDP films having a 5% PTSA-BC treatment after each coating. Anodes with internal non-polyaniline ICP coatings and external PANi/DNNSA-SDP films but without the additional PTSA treatment have Δ-ESR values of ˜50 mΩ after 2 hours at 200° C.; and

FIG. 25 is an illustration of a cross-sectional view of a valve-metal capacitor showing various parts of the capacitor.

### DETAILED DESCRIPTION OF THE PREFERRED EMBODIMENTS

In accordance with the present invention, it has been discovered that a film of a conductive polymer having improved thermal stability can be produced by providing a film of an electrically conductive polymer having as a dopant a first protonic acid that is selected to solubilize the doped conductive polymer in a first organic solvent, and contacting the film with a mixture of a second organic solvent and a second protonic acid.

This has been found to be particularly useful for improvement of the thermal stability of conductive films of high integrity that are formed on a surface by applying to the surface a mixture of a first organic solvent and an electrically conductive polymer having as a dopant a first protonic acid that is selected to solubilize the doped conductive polymer in the first organic solvent, and removing the first organic solvent and forming a film of the doped electrically conductive polymer.

In an embodiment of the present method where a film of polyaniline doped with dinonylnaphthalenesulfonic acid and containing 4,4′-sulfonyldiphenol was applied as a cathode for a solid electrolyte tantalum capacitor, it was shown that dipping the film into a 5% by weight solution of p-toluenesulfonic acid in butylcellosolve and drying the film significantly improved the thermal stability of the film. The treatment also dramatically reduced the shift in equivalent series resistance (Δ-ESR) caused by thermal stress conditions of 260° C. for 15 seconds so that the Δ-ESR was less than about 5 mΩ while maintaining the current leakage of the capacitor and the conductivity of the conductive polymer at acceptable levels.

As used herein, the terms “electrically conductive polymer”, “inherently conductive polymer” (ICP), or “conductive polymer” refer to an organic polymer that contains polyconjugated bond systems and which can be doped with electron donor dopants or electron acceptor dopants to form a charge transfer complex that has an electrical conductivity of at least about 10⁻⁸ S/cm. It will be understood that whenever an electrically conductive polymer, ICP, or conductive polymer is referred to herein, it is meant that the material is associated with a dopant.

The term “dopant”, as used herein, means any protonic acid that forms a salt with a conductive polymer to give an electrically conductive form of the polymer. A single acid may be used as a dopant, or two or more different acids can act as the dopant for a polymer.

Although any conductive polymer can be used in the present invention, examples of useful polymers include polyaniline, polypyrrole, polyacetylene, polythiophene, poly(phenylene vinylene), and the like. Polymers of substituted or unsubstituted aniline, pyrrole, or thiophene can serve as the conductive polymer of the present invention. In one embodiment, the conductive polymer is polyaniline.

Polyaniline occurs in at least four oxidation states: leuco-emeraldine, emeraldine, nigraniline and pernigraniline. The emeraldine salt is a form of the polymer that exhibits a stable electrically conductive state. In the emeraldine salt form of polyaniline, the presence or absence of a protonic acid dopant (counterion) can change the state of the polymer, respectively, from emeraldine salt to emeraldine base. Thus, the presence or absence of such a dopant can reversibly render the polymer conductive, or non-conductive. The use of protonic acids as dopants for conductive polymers such as polyaniline is known and simple protonic acids such as HCl and H₂SO₄, or with functionalized organic protonic acids such as p-toluenesulfonic acid (PTSA), or dodecylbenzenesulfonic acid (DBSA) results in the formation of conductive polyaniline.

Although electrical conductivity is often a key property of the final product of a conductive polymer, conductive polymers in their conductive forms are often difficult to process. Doped polyaniline, for example, is typically insoluble in all organic solvents, while the neutral form is soluble only in highly polar solvents, such as N-methylpyrrolidone. It has been found, however, that certain methods of synthesis, and the use of certain functionalized organic acid dopants, rendered electrically conductive polyaniline salt more soluble in organic solvents. See, e.g., U.S. Pat. Nos. 5,863,465 and 5,567,356, (use of hydrophobic counterions in emulsion polymerization with polar organic liquids) and WO 92/22911 and U.S. Pat. Nos. 5,324,453 and 5,232,631, (use of counterions having surfactant properties in emulsion polymerization with non-polar organic liquids).

As discussed briefly above, it was found that a film of an electrically conductive polymer could be provided by applying a mixture of the polymer in an organic solvent to a surface and removing the solvent. In many applications it is advantageous to use an organic solvent for this step. When an organic solvent is used, it was found to be advantageous to intermix a first organic solvent with an electrically conductive polymer having as a dopant a first protonic acid that was selected to solubilize the doped conductive polymer in the first organic solvent. After application of the solvent/polymer mixture to the surface, the solvent was removed, thereby forming a film of the doped electrically conductive polymer.

The first organic solvent of the present invention can be an organic solvent having a dielectric constant that is lower than about 20 at room temperature. Alternatively, the first organic solvent can have a dielectric constant of less than 10, or less than 5, less than 4, or less than 3.

The first organic solvent can be a single material or it can be a mixture of two or more organic solvents. Examples of solvents that are suitable for use in the present invention as the first organic solvent include xylene, or a mixture of xylenes. Another example of a suitable first organic solvent that is a mixture of organic solvents is a mixture of butylcellosolve and xylene(s). As an example, a mixture of from about 1:1.2 to about 1:1.5 butylcellosolve-to-xylenes by weight is useful as a first organic solvent.

The first protonic acid that is selected to solubilize the doped conductive polymer in the first organic solvent can be any organic protonic acid that can serve as a dopant for polyaniline and that provides sufficient solubility of the doped conductive polymer in mixed xylenes at room temperature to allow a film to be formed from the mixture (by spin-coating, drawdown, or other coating method) that is a free-standing film of about 10 microns thick or less without the use of added binder(s).

In general, the first protonic acid can be an alkylated aromatic mono-sulfonic acid or alkyl mono-sulfonic acid. Di-, tri-, or poly-functional sulfonic acids are generally not useful because they lead to gel network formation. Examples of particular materials that are useful as the first protonic acid are described in U.S. Pat. Nos. 4,983,322, 5,006,278, 5,567,356, 5,624,605, and 5,863,465. Particular examples of materials that are useful as the first protonic acid include camphorsulfonic acid, dodecylbenzenesulfonic acid, and dinonylnaphthalene sulfonic acid (DNNSA).

One example of a suitable mixture of a first organic solvent with an electrically conductive polymer having as a dopant a first protonic acid that is selected to solubilize the doped conductive polymer in the first organic solvent is (in percent by weight):

Polyaniline 3.6%

Dinonylnaphthalene sulfonic acid 21.4%

Xylenes (mixed isomers) 44.4%

Butylcellosolve 30.6%

It has also been found to be useful to provide a film of an electrically conductive polymer that further contains 4,4′-sulfonyldiphenol (CAS RN 80-09-1) in addition to the first protonic acid dopant. 4,4′-sulfonyldiphenol can also be referred to as SDP, sulfonyldiphenol, 4,4′-Dihydroxydiphenylsulfone, Bisphenol S, Bis(4-hydroxyphenyl) sulfone, 4,4′-Dihydroxydiphenyl sulfone, 4,4′-Sulfonyldiphenol (4,4′-Dihydroxydiphenylsulfone), 4,4′-Dihydroxy Diphenyl Sulfone Bisphenol-S, or 4,4′-Dihydroxy Diphenylsulfone (Bisphenol S). An example of a mixture of a first organic solvent with an electrically conductive polymer having as a dopant a suitable first protonic acid, where the mixture contains SDP, is (in percent by weight):

Polyaniline 3.3%

Dinonylnaphthalene sulfonic acid 19.7%

4,4′-sulfonyldiphenol 2.6%

Xylenes (mixed isomers) 41.1%

Butylcellosolve 33.4%

The term “film”, as used herein in conjunction with the description of a conductive polymer, means a solid form of the polymer. Unless otherwise described, the film can have almost any physical shape and is not limited to sheet-like shapes or to any other particular physical shape. Commonly, a film of a conductive polymer can conform to the surface of the dielectric layer of a solid electrolyte capacitor.

“Thermal stability”, as used herein to describe a material, means the ability of the material to resist decomposition or degradation when exposed to an elevated temperature for an extended period of time as measured by isothermal gravimetric analysis. The terms “improved thermal stability”, mean any improvement in the thermal stability of a material, no matter how small.

The term “mixture”, as used herein, refers to a physical combination of two or more materials and includes, without limitation, solutions, dispersions, emulsions, micro-emulsions, and the like.

In the present method, the film of the conductive polymer having the first protonic acid dopant is contacted with a mixture of a second organic solvent and a second protonic acid.

The second protonic acid can be any protonic acid that can act as a dopant for the conductive polymer. The second protonic acid can be the same as the first protonic acid, or it can be a different protonic acid, or it can be a mixture of the first protonic acid and a different protonic acid, or it can be a mixture of two or more protonic acids, any one of which can be the same or different than the first protonic acid.

In an embodiment of the present method, the second protonic acid can act as a dopant that when combined with a conductive polymer not only provides electrical conductivity but also improves the thermal stability of the conductive polymer.

Examples of materials that are suitable for use as the second protonic acid of the present invention include, without limitation, 4-sulfophthalic acid (4-SPHA), p-toluenesulfonic acid (PTSA), benzenesulfonic acid (BA), phenylphosphonic acid (PA), phosphoric acid (H₃PO₄), and camphorsulfonic acid (CSA), among others. Further examples of acids that are useful as the second protonic acid are described in U.S. Pat. No. 5,069,820. In one embodiment, the second protonic acid comprises an organic sulfonic acid. The acid can have one, two, three, or more sulfonate groups. An example of a suitable organic sulfonic acid is a compound having the formula:

R₁HSO₃

where R₁ is a substituted or unsubstituted organic radical.

Another example of a material that is suitable for use as the second protonic acid dopant is a compound having the formula:

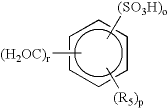

wherein: o is 1, 2 or 3; r and p are the same or are different and are 0, 1 or 2; and R₅ is alkyl, fluoro, or alkyl substituted with one or more fluoro or cyano groups.

In the previous structure, it is also suitable when: o is 1 or 2; r and p are the same or are different and are 0 or 1; and R₅ is alkyl, fluoro, or alkyl substituted with one or more fluoro or cyano groups.

In one embodiment, the second protonic acid dopant comprises p-toluenesulfonic acid.

The second organic solvent of the present method is an organic solvent or a mixture of organic solvents in which the first protonic acid is at least partially soluble. In an embodiment, the second organic solvent is a liquid in which the first protonic acid is more soluble than the doped conductive polymer. This permits the preferential solvation of excess amounts of the first protonic acid relative to the solvation of the doped conductive polymer, thereby allowing preferential removal of excess amounts of the first protonic acid from the doped conductive polymer. In one embodiment, the second organic solvent is a liquid having a higher dielectric constant than the first organic solvent.

Generally, a second organic solvent is selected so that it will dissolve both the second protonic acid and the first protonic acid. Therefore, a second organic solvent should be at least mildly polar, such as butylcellosolve (dielectric constant (DC)=9.4), n-butanol (DC=17.8), and the like, which are sufficiently polar to dissolve p-toluenesulfonic acid and sufficiently non-polar to dissolve dinonyinaphthalenesulfonic acid.

Examples of suitable second organic solvents of the present invention include n-butanol, butylcellosolve, and mixtures thereof.

In the present method, the mixture of the second organic solvent and a second protonic acid generally comprises the second protonic acid in an amount that is selected to improve the thermal stability of the conductive polymer film and to decrease the loss of electrical conductivity caused by thermal stress (which reduces the shift in equivalent series resistance (Δ-ESR) in capacitors).

Typically, the mixture of the second organic solvent and a second protonic acid can comprise the second protonic acid in an amount of from about 0.5% to about 25%. The mixture can also contain the second protonic acid in an amount of from about 1% to about 15%, or from about 3% to about 7%, all in percent by weight.

Although the mixture of the second organic solvent and a second protonic acid can further comprise almost any other additive that increases the effectiveness of the contacting process, it is typically free of monomer of the conductive polymer and free of the conductive polymer before it contacts the doped conductive polymer film. Optionally, the mixture can consist essentially of the second organic solvent and a second protonic acid.

When the mixture of the second organic solvent and a second protonic acid is contacted with the doped conductive polymer film, any type of contacting can be used. For example, the mixture can be sprayed on the film, or painted on the film, or the film can be dipped in the mixture. In one example, the film is dipped into the mixture and allowed to remain for a period of from about 1 second to about 120 seconds. The time can be from about 5 seconds to about 60 seconds, or from about 10 seconds to about 30 seconds.

During the contacting process, the temperature of the film and of the mixture can be from about 5° C. to about 50° C., or can be from about 10° C. to about 30° C., or it can be about room temperature.

In one embodiment, the concentration of the second protonic acid in the second organic solvent and the time of contacting the mixture with the conductive polymer film (the contacting conditions) are selected to improve the thermal stability so that weight loss of the treated electrically conductive polymer film in 120 minutes at 200° C. is less than about 20%, and that loss of electrical conductivity is under 30% after the same treatment. Alternatively, the contacting conditions are selected so that the weight loss is less than about 10%, and that loss of electrical conductivity is under 20%, or that weight loss is less than about 5%, and that loss of electrical conductivity is under 10% after the same treatment after the same treatment.

As mentioned above, one particular application of the present invention is for the treatment of conductive polymer films that act as the cathode of solid electrolyte valve-metal capacitors.

As employed herein, the phrase “valve metal” has the same meaning attributed to it in the literature, including the references mentioned above, and includes, illustratively, titanium, tantalum, tungsten, aluminum, hafnium, niobium, or zirconium, including alloys thereof.

In the present method, a capacitor body is provided that comprises an anode of the valve-metal, a dielectric metal oxide layer, and an electrically conductive polymer film cathode having a thermal stability and which comprises a conductive polymer having as a dopant a sufficient amount of a first protonic acid to solubilize the polyaniline in a first organic solvent, and contacting the film with a second organic solvent containing a second protonic acid.

In one embodiment, the first protonic acid is more soluble than the doped electrically conductive polymer in the second organic solvent.

As discussed above, the step of providing a film of an electrically conductive polymer can comprise applying over the dielectric metal oxide layer a mixture of the first organic solvent and the electrically conductive polymer having as a dopant a first protonic acid that is selected to solubilize the conductive polymer in the first organic solvent, and removing the first organic solvent and forming a film of the doped electrically conductive polymer on the dielectric metal oxide layer.

A particularly useful example of the present method is when the first protonic acid dopant comprises dinonylnaphthalenesulfonic acid and the second protonic acid dopant comprises p-toluenesulfonic acid. Also useful is the example where the first organic solvent comprises xylene and the second organic solvent comprises n-butanol, butylcellosolve, or a mixture thereof.

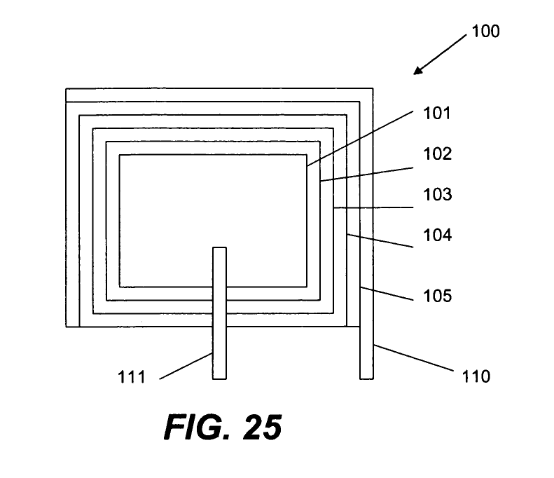

An example of this application could include the following steps. Numbering of elements corresponds to numbering shown in FIG. 25:
an anode (101) comprising a sintered tantalum body is provided. The anode body can have an anode lead (111) attached to the anode and designed to connect the anode side of the capacitor to an electronic circuit,
the anode body is anodized in an acid bath to coat the tantalum with a dielectric layer of tantalum oxide (102),
the anode having a dielectric metal oxide layer is dip-coated into a solution of polyaniline doped with dinonylnaphthalene sulfonic acid with or without added SDP (PANi/DNNSA or PANi/DNNSA-SDP).
A solution without SDP can have the composition:
   Polyaniline 3.6%
   Dinonylnaphthalene sulfonic acid 21.4%
   Xylenes (mixed isomers) 44.4%
   Butylcellosolve 30.6%
and a solution with SDP can have the composition:
   Polyaniline 3.3%
   Dinonylnaphthalene sulfonic acid 19.7%
   4,4′-sulfonyldiphenol 2.6%
   Xylenes (mixed isomers) 41.1%
   Butylcellosolve 33.4%
The anode is dipped into the solution for 30 seconds to deposit a film of the conductive polymer,
the anodes are air-dried for 30-minutes at room temperature,
the anodes are oven-dried at 150° C. for 30 minutes to form a solid film of the doped conductive polymer (103),
the anodes are cooled to room temperature for a minimum of 30 minutes; and optionally
the anodes are dipped for 30 seconds into a “treatment solution”, which can be a 5 wt % solution of a second protonic acid such as p-toluenesulfonic acid (PTSA) in an organic solvent such as n-butanol, butylcellosolve, or a mixture of the two. (If the anodes are treated in the acid/organic solvent step, the treated anodes are air-dried for 10-30 minutes at room temperature and then oven-dried at 150° C. for 30 minutes for 30 minutes).
Further optional steps can include:
optionally repeating some or all of the steps shown above,
optionally dipping the treated anodes for 30 seconds into a final “rinse” solution, usually an organic solvent such as xylenes,
applying a carbon layer (104) to the anodes by dipping them for 30 seconds into a carbon ink, air-drying for 10 minutes at room temperature, oven-drying at 100° C. for 30 minutes, and cooling to room temperature for a minimum of 30 minutes,
applying a silver layer (105) to the anodes by dipping them for 30 seconds into a silver ink, air-drying for 30 minutes at room temperature, oven-drying at 150° C. for 30 minutes, and cooling to room temperature for a minimum of 30 minutes, and
applying a cathode lead (110) for connecting the cathode side of the capacitor (100) to an electronic circuit.

During the production of some solid electrolyte capacitors, it is common to apply one or more layers of a conductive polymer such as polypyrrole directly to the metal oxide dielectric layer of a porous valve-metal anode. A final layer of the same or a different conductive polymer, such as polyaniline, can then be applied over the previous conductive polymer layers. The present invention encompasses the application of the present method to any one of or all of the layers of conductive polymer.

The following examples describe preferred embodiments of the invention. Other embodiments within the scope of the claims herein will be apparent to one skilled in the art from consideration of the specification or practice of the invention as disclosed herein. It is intended that the specification, together with the examples, be considered to be exemplary only, with the scope and spirit of the invention being indicated by the claims which follow the examples. In the examples all percentages are given on a weight basis unless otherwise indicated.

### EXAMPLE 1

This example illustrates the effect of using different organic solvents to treat films of polyaniline doped with dinonylnaphthalene sulfonic acid (PANi/DNNSA) and having excess dinonylnaphthalene sulfonic acid (DNNSA).

PANi/DNNSA films were prepared on glass slides (2×3 in²) via spin-coating. The films were then dried at 150° C. for 30 minutes. The films were soaked in various organic solvents, dried again at 150° C. for 30 minutes, and then a pair of silver bars was screen-printed on the films. In an effort to select organic solvents that would dissolve and remove the excess DNNSA without completely dissolving away the deposited, cured films, the following organic solvents were evaluated: butylcellosolve (BC, also known as 2-butoxyethanol), n-butanol (nBuOH), isopropanol (iPrOH), methanol (MeOH), xylenes (mixture of isomers), and selected mixtures of these.

The film thickness and surface resistance of each film was determined experimentally and these measurements were used to calculate the bulk film conductivity (σ) with the equation: σ=1/SR*d, where SR is the surface resistivity and d is the film thickness.

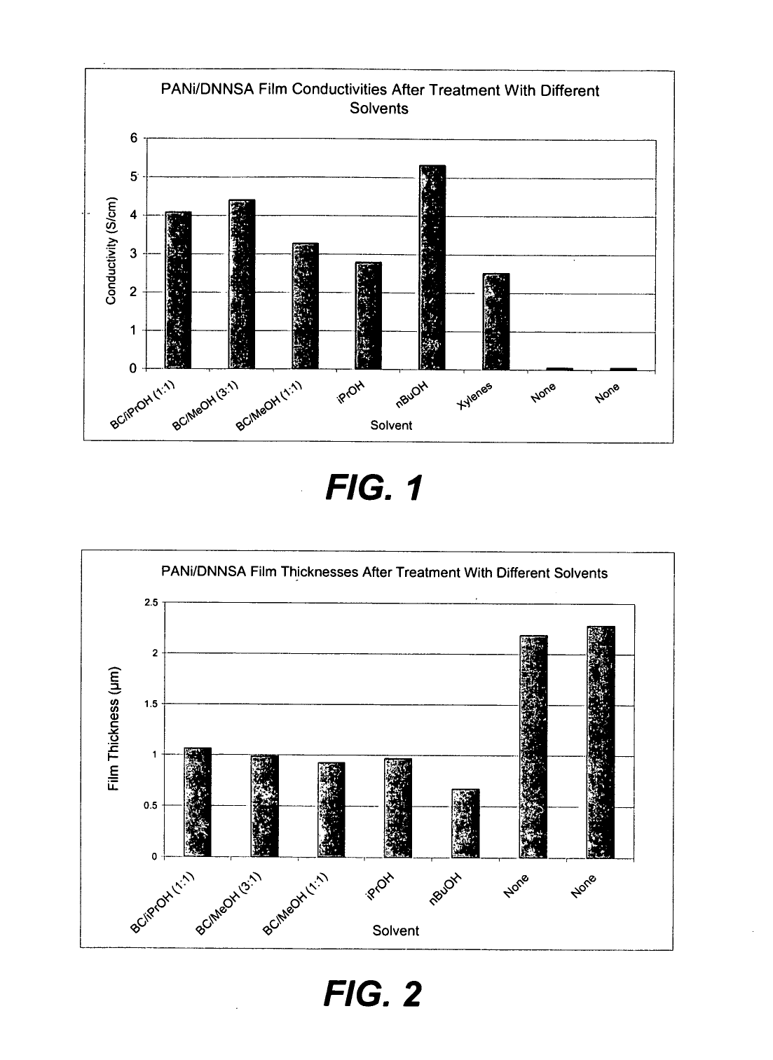

Untreated PANi/DNNSA films had conductivities of ˜0.06 S/cm, but soaking the films in the organic solvents and solvent mixtures shown above increased the film conductivities by up to two orders of magnitude, to values between 2 and 6 S/cm. FIG. 1 shows the conductivities of the PANi/DNNSA films treated with various organic solvents. It was also noted that the solvent treatment reduced the thickness of the PANi/DNNSA films by more than half (see FIG. 2), which indicated that a significant portion of dopant was removed from the films.

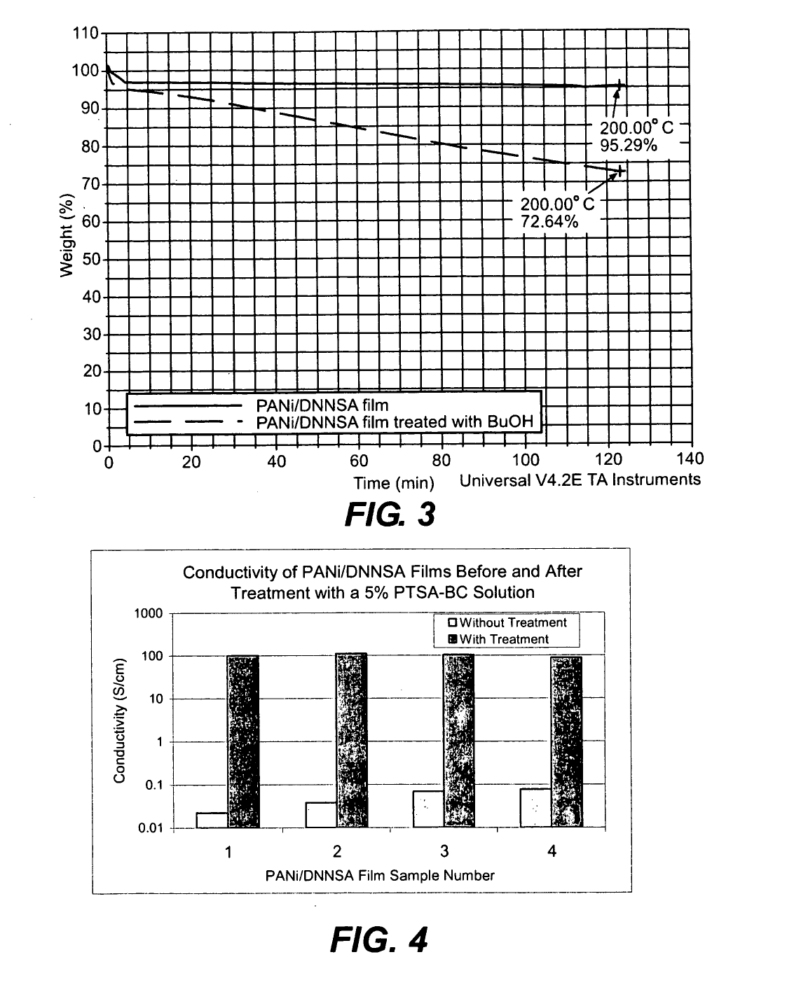

The thermal stability of an nBuOH-treated PANi/DNNSA film was determined by isothermal thermogravimetric analysis (TGA) and compared with the thermal stability of an untreated film of the same type. The temperature of the film sample was quickly raised to 200° C. and then held at 200° C. for 2 hours. The results, shown in FIG. 3, indicated that at 200° C., the degradation and weight loss in untreated PANi/DNNSA films was rapid and that solvent-treated PANi/DNNSA films had significantly less weight loss and exhibited better thermal stability. It was noted that an initial weight loss of 4-8 wt % for each sample was observed due to evaporation of trapped solvent or other volatile material.

It was noted that contact of the conductive polymer films with solvent alone (without acid) appears to reduce the film integrity and result in films that break apart, and lack strength and durability.

### EXAMPLE 2

This example illustrates the effect of using 5 wt % p-toluenesulfonic acid (PTSA) in organic solvents to treat films of polyaniline doped with dinonylnaphthalene sulfonic acid (PANi/DNNSA) and having excess dinonylnaphthalene sulfonic acid (DNNSA).

While a PANi/DNNSA material with high conductivity and processability/coatability is important for the production of useful capacitors, it is also important to provide a material that is stable under prolonged heating at elevated temperatures (up to 200° C.).

It is known from U.S. Pat. No. 5,160,457 that PTSA-doped polyaniline can be prepared by exchange of dopant ions in polyaniline-hydrochloride with p-toluenesulfonate anions. The resulting PTSA-doped polyaniline compound was reported to have only a 2% weight loss when heated to 300° C. and a 5% weight loss when heated to 400° C., as determined by thermogravimetric analysis (TGA). Examples in the patent taught carrying out the chloride to PTSA ion exchange in aqueous solutions.

In view of the reported improved thermal stability of PTSA-doped polyaniline, a modified ion exchange method was proposed to improve the thermal stability of the present PANi/DNNSA materials. In the present modified ion exchange method, a goal was to remove much of the excess DNNSA from the films while simultaneously exchanging the DNNSA dopant with PTSA. It was also believed to be desirable to employ organic solvents rather than aqueous solutions for this process, because PANi/DNNSA and its components (PANi/DNNSA and DNNSA) are not water-soluble. It was not known, however, whether the ion exchange in organic solution would be possible, because PTSA is much less ionized in organic solvents than in aqueous solutions. In fact, it was found that the type of organic solvent that was selected was important to the success of the process. It was found to be necessary to select an organic solvent that would dissolve both the PTSA and the DNNSA to allow for the ion exchange, but that would also not be so strong as to completely dissolve away the deposited, cured PANi/DNNSA films.

Four samples of PANi/DNNSA films were prepared on glass slides (2×3 in²) via spin-coating as described in Example 1, and the films were dried at 150° C. for 30 minutes. One half of each film was then soaked in a 5 wt % solution of PTSA in butylcellosolve (BC) and dried again at 150° C. for 30 minutes. A pair of silver contact bars was then screen-printed on each film sample half. The film thickness and surface resistivity were determined and the conductivity of each film was calculated.

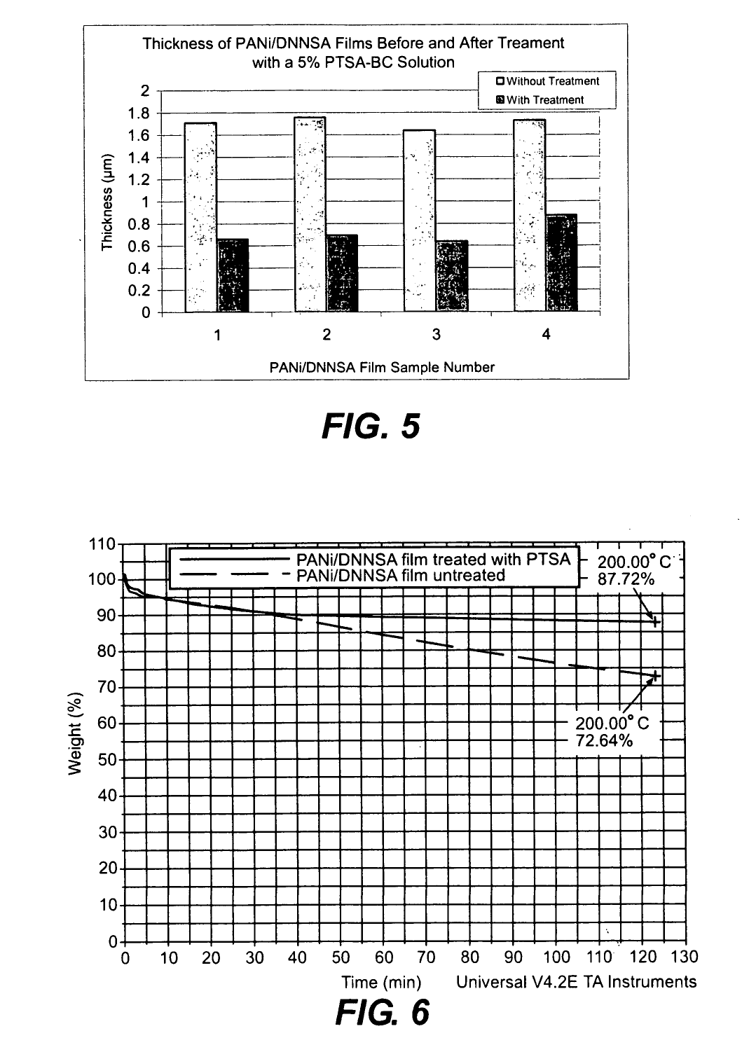

The results are shown in FIG. 4 and indicate that each of the treated PANi/DNNSA films exhibited a conductivity ranging between 100 and 200 S/cm, which is much higher than that of untreated PANi/DNNSA (˜0.06 S/cm), or of PANi/DNNSA films treated with solvents only as shown in Example 1 (˜2-6 S/cm), and untreated PANi/DNNSA films having added 4,4′-sulfonyldiphenol (SDP) (˜20-40 S/cm). The conductivity improvement implied that at least some DNNSA was exchanged for PTSA which migrated into the treated films to enhance film conductivity. Furthermore, the treated films lost half of their thickness, as shown in FIG. 5, indicating significant removal of excess dopant.

The thermal stability of a PANi/DNNSA film that had been treated by the method described above was compared with the thermal stability of an untreated PANi/DNNSA film (FIG. 3). Thermal stability was determined by isothermal thermogravimetric analysis that involved quickly raising the temperature of the sample to 200° C. and then holding at 200° C. for 2 hours. As shown in FIG. 6, it was found that at 200° C., the degradation and weight loss in untreated PANi/DNNSA films was rapid but PTSA-treated PANi/DNNSA films demonstrated significantly better thermal stability. It was noted that an initial weight loss of 4-8 wt % was observed due to evaporation of trapped solvent or other volatile material.

### EXAMPLE 3

This example illustrates the solvent treatment of films of polyaniline doped with dinonylnaphthalene sulfonic acid and 4,4′-sulfonyldiphenol (PANi/DNNSA-SDP) plus excess dinonyinaphthalene sulfonic acid (DNNSA).

PANi/DNNSA-SDP films were prepared on glass slides (2×3 in²) via spin-coating from a solution of PANi/DNNSA with added SDP in a mixture of butylcellosolve and mixed xylenes. The films were dried at 150° C. for 30 minutes. The PANi/DNNSA-SDP solution was prepared by adding 2.5% by weight of SDP to a 25% (by weight) solution of PANi/DNNSA in a mixture of 1 part butylcellosolve to 1.5 parts xylenes (by weight). The films were soaked in various organic solvents, dried again at 150° C. for 30 minutes, and then a pair of silver bars was screen-printed on the films. As with the studies with PANi/DNNSA films, organic solvents were selected for testing to find a solvent that would dissolve and remove (or neutralize) the excess DNNSA without completely dissolving away the deposited, cured films. The following solvents were tested: butylcellosolve (BC, also known as 2-butoxyethanol), n-butanol (nBuOH), isopropanol (iPrOH), methanol (MeOH), xylenes (mixture of isomers), aqueous buffer systems (to neutralize the DNNSA), and selected mixtures of these.

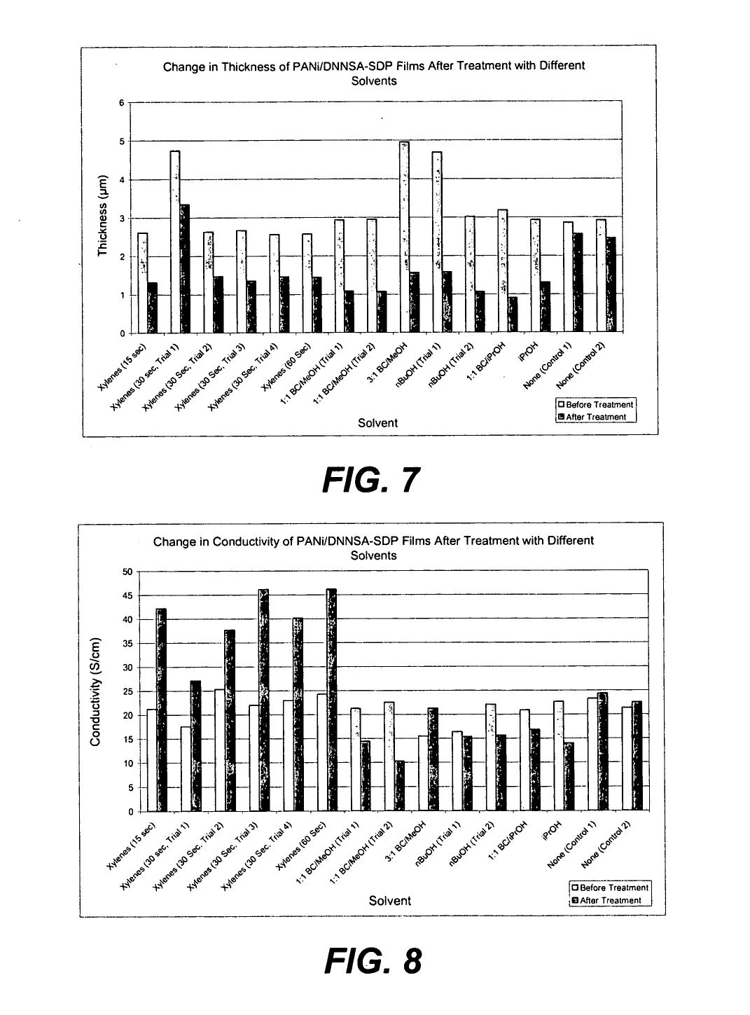

The film thickness and surface resistance of each treated film was determined experimentally, from which the bulk film conductivity was calculated as previously described. Film thicknesses before and after treatment are shown in FIG. 7, and selected electrical conductivity results are summarized in FIG. 8.

It was found that when alcohol-based solvents (for example nBuOH) were used for the treatment, each of the films exhibited a conductivity ranging from 10 to 16 S/cm, which is less than that of untreated PANi/DNNSA-SDP (20-40 S/cm). Furthermore, compared with untreated PANi/DNNSA-SDP films, the thickness of the treated films was reduced by more than half, clearly indicating that the solvent treatment removed a significant portion of the dopant from the film.

When xylenes were used for the solvent treatment, however, the film conductivity increased from 20-30 S/cm to 40-50 S/cm while the film thickness was reduced by half or more. Without being bound to this or any other theory, it was believed that the use of xylenes for the solvent treatment did not alter the pre-formed conducting network in the film because SDP is not soluble in xylenes. Thus the conductivity increase was due to the film thickness reduction. In contrast, SDP is soluble in alcohols, so solvent treatment with alcohols not only removed excess DNNSA but also partially impaired the conducting network.

Treatment of the same films with aqueous buffer systems was also evaluated and these results are discussed below in Example 8.

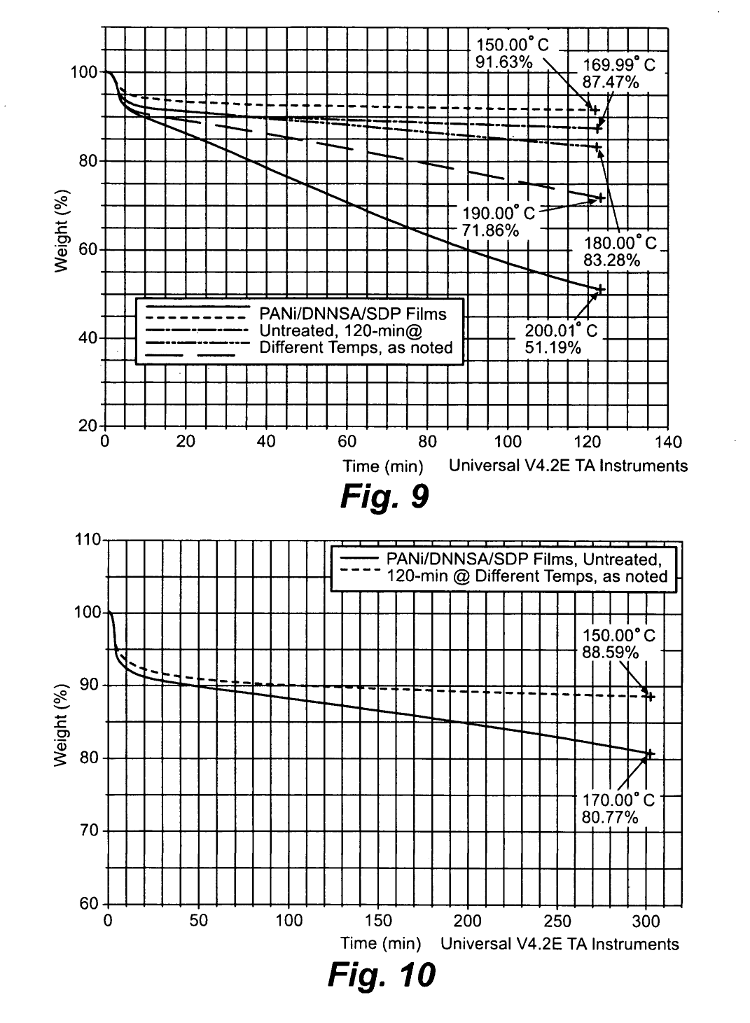

The thermal stability of treated and untreated PANi/DNNSA-SDP films was evaluated by thermogravimetric analysis (TGA). First the stability of untreated PANi/DNNSA-SDP films was established by isothermal TGA at several different temperatures between 150° C. and 200° C. The tests were conducted by quickly raising the sample to the desired temperature and then holding at that temperature for 2 hours (results shown in FIG. 9) or 5 hours (results shown in FIG. 10). It was found that the untreated films were relatively stable to weight loss at 150° C., but at temperatures above 150° C., the films steadily lost significant weight, indicating film degradation. At 200° C., the degradation and weight loss in untreated PANi/DNNSA-SDP films is rapid.

In all films studied by isothermal TGA, an initial weight loss of 4-8 wt % was observed due to evaporation of trapped solvent or other volatile material. The results shown in FIG. 9 also suggested that the weight loss was proportional to heating time, which could be quantified. Table 1 summarizes the film weight information. The results there show that the films lose almost half of their original weight after heated at 200° C. for 2 hours.

TABLE 1
Weight loss in PANi/DNNSA-SDP films after heating at different
temperatures for 2 hours:

| | Isothermal | |
|---|---|---|
| | Temperature | Film Weight |
| Sample No. | (° C.) | % Remaining |
| 1 | 150 | 92 |
| 2 | 170 | 87 |
| 3 | 180 | 83 |
| 4 | 190 | 72 |
| 5 | 200 | 51 |

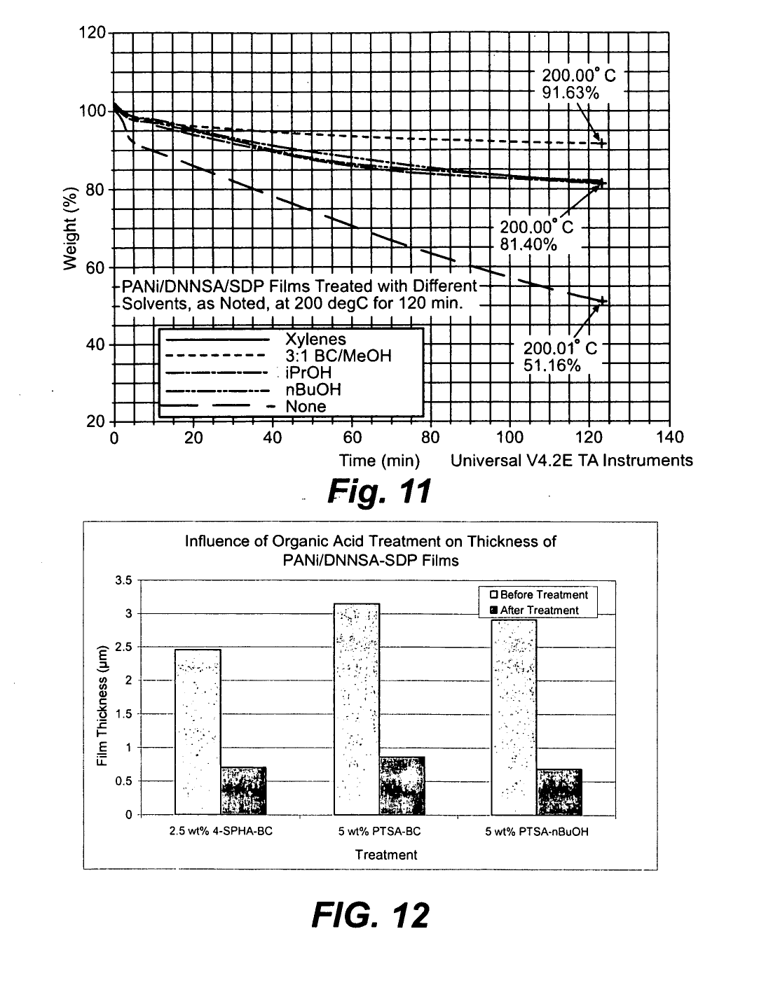

The thermal stability of several types of films was compared by subjecting the films to isothermal, two-hour TGA scans. TGA results are shown in FIG. 11 for films of untreated PANi/DNNSA-SDP, extracted PANI-DNNSA powder (“pure” polyaniline emeraldine salt with no excess/free DNNSA acid) and films treated with selected solvents to remove excess DNNSA. The PANI-DNNSA powder was found to be the most stable. The solvent treatments improved the thermal stability of PANi/DNNSA-SDP films, with some solvents being more effective than others. For example, a 3:1 ratio of BC and MeOH greatly improved the film stability, but xylenes were somewhat less effective.

### EXAMPLE 4

This example illustrates the treatment of films of polyaniline doped with dinonylnaphthalene sulfonic acid and sulfonyldiphenol (PANi/DNNSA-SDP) plus excess dinonylnaphthalene sulfonic acid (DNNSA) with 5% by wt. p-toluenesulfonic (PTSA) acid in organic solvents.

PANi/DNNSA-SDP films were prepared on glass slides (2×3 in²) via spin-coating as described above in Example 3 and the films were dried at 150° C. for 30 minutes. One half of each film was then soaked in a 5 wt % solution of PTSA in organic solvent and dried again at 150° C. for 30 minutes. For comparison, a 2.5 wt % solution of 4-sulfophthalic acid (4-SPHA) was also evaluated. A pair of silver contact bars was then screen-printed on each film sample half. The film thickness and surface resistivity of each film was determined and the conductivity was calculated. Both butylcellosolve (BC) and n-butanol (nBuOH) were evaluated as the solvent for PTSA treatment.

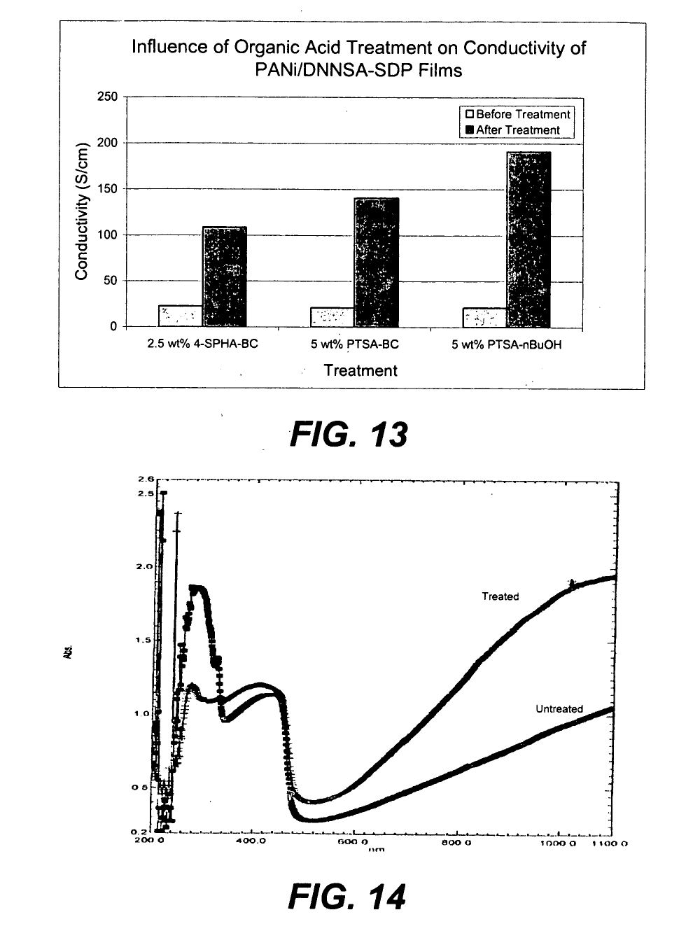

The results, shown in FIG. 12 and FIG. 13, indicate that treatment of PANi/DNNSA-SDP films with 5 wt % solutions of PTSA reduced the film thicknesses by about half and increased the conductivity to values ranging from 100 to 200 S/cm. These conductivities are much higher than normally observed for untreated PANi/DNNSA-SDP films (˜20-40 S/cm) and similar to those observed in PTSA-treated PANi/DNNSA films.

UV-Vis spectroscopy can be used to confirm or qualify the observed increase in film conductivity upon PTSA treatment. FIG. 14 is a set of UV-Vis spectra for PANi/DNNSA-SDP films with and without treatment with a 5 wt % solution of PTSA in BC. The absorption tail from 500 to 1100 nm, associated with the free carrier or conduction band, is intensified upon PTSA treatment. This result agrees with the observed increase in film conductivity. Similar behavior was observed when PANi/DNNSA-SDP films were treated with other acids in organic solvents, such as 5 wt % phosphoric acid in BC and/or 5 wt % camphorsulfonic acid in BC.

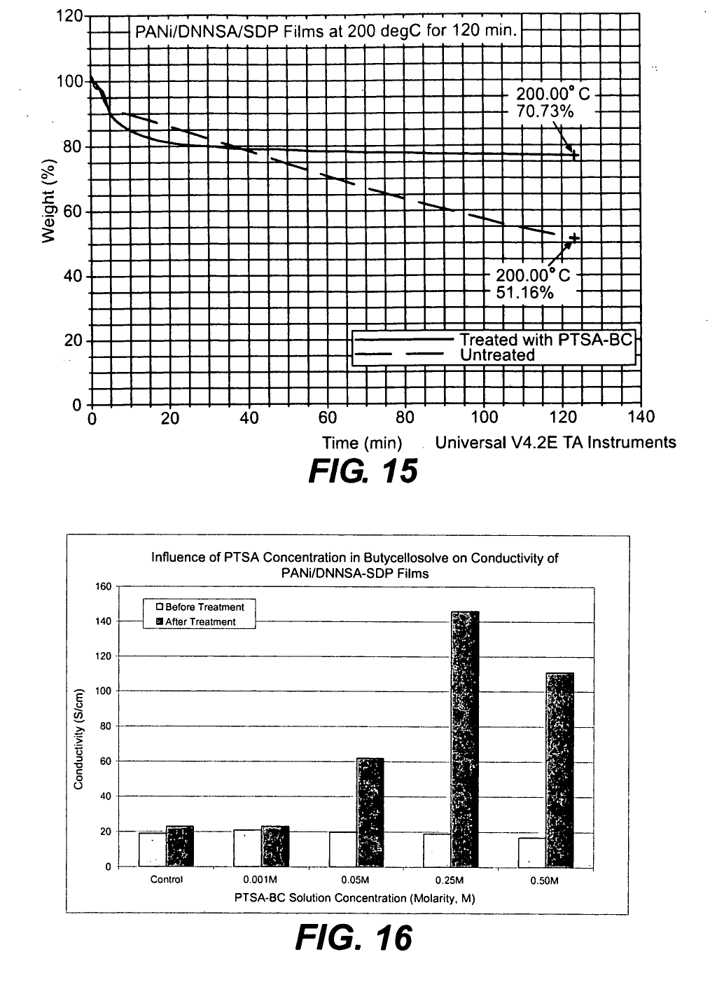

Thermogravimetric analysis (TGA) of PTSA-treated PANi/DNNSA-SDP film (FIG. 15) showed that the film exhibited reasonable thermal stability under isothermal heating at 200° C. for 2 hours. Furthermore, TGA of the 4-SPHA-treated films indicated that the films exhibited good thermal stability, with ˜10% wt loss or less after isothermal heating at 200° C. for 2 hours.

### EXAMPLE 5

This example shows the effect of the concentration of p-toluenesulfonic acid (PTSA) in the organic solvent treating solution on the conductivity and thermal stability of treated films of polyaniline doped with dinonylnaphthalene sulfonic acid and sulfonyldiphenol (PANi/DNNSA-SDP) plus excess dinonylnaphthalene sulfonic acid (DNNSA).

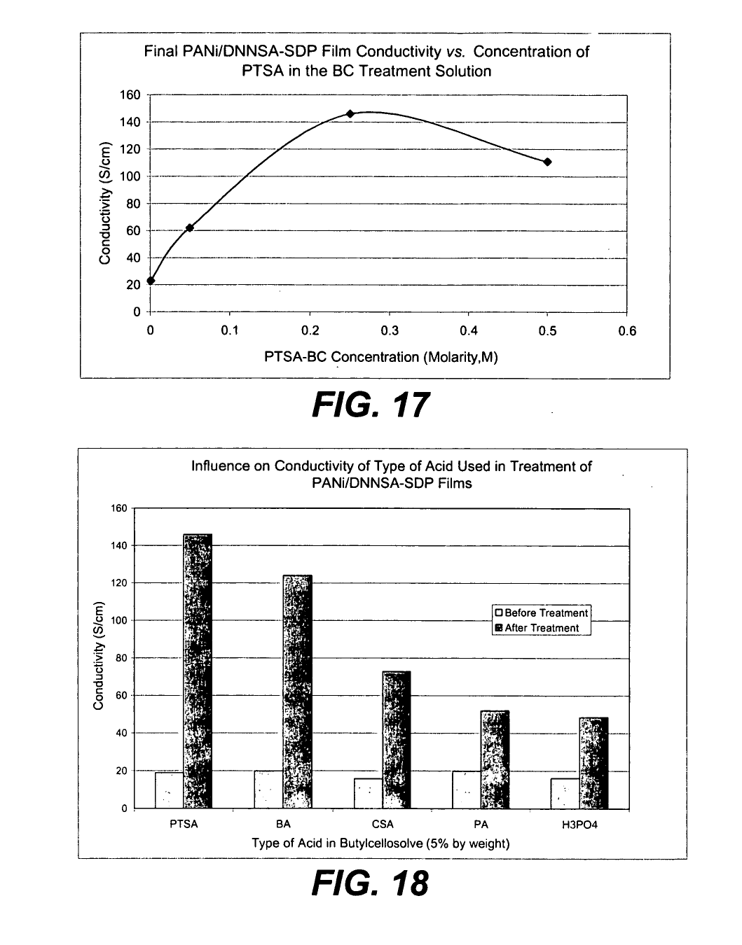

PANi/DNNSA-SDP films were prepared as described above in Example 4 and treated with solutions of PTSA in butylcellosolve (BC) at various concentrations. Testing for electrical conductivity showed (in FIG. 16 and FIG. 17) that conductivity increased dramatically when the PTSA concentration was at least 0.05 M. At a PTSA concentration of 0.25 M, which is close to the 5 wt % level used in the studies described above, the conductivity peaked at about 150 S/cm. Further increase in PTSA concentration led to smaller increases in film conductivity.

### EXAMPLE 6

This example shows the effect of the type of acid used in the treatment on the electrical conductivity of treated films of polyaniline doped with dinonylnaphthalene sulfonic acid and sulfonyldiphenol (PANi/DNNSA-SDP) plus excess dinonylnaphthalene sulfonic acid (DNNSA). As noted above and shown in FIG. 12 and FIG. 13, it was shown that the use of 4-sulfophthalic acid (4-SPHA), a smaller alternative to PTSA, led to results very similar to those found when PTSA was used. This suggested that a variety of small organic acids in organic solvents could be employed to improve the film conductivity. The following acids were evaluated: benzenesulfonic acid (BA) in butylcellosolve (BC), phenylphosphonic acid (PA) in BC, phosphoric acid (H₃PO₄) in BC, and camphorsulfonic acid (CSA) in BC.

A comparison of film conductivity results for PANi/DNNSA-SDP films treated with 0.25 M PTSA in BC and with each of the solutions noted above is shown in FIG. 18 and in Table 2. In general, the results show film conductivity increases of three to more than seven times that of untreated films, and PTSA is seen to be superior to other acids tested as 5 wt % solutions in BC. When PA, a weak acid compared to PTSA or BA, is used, the film conductivity only increases to 50-60 S/cm. The conductivity of the treated PANi/DNNSA-SDP film, however, is still much higher than that of PANi/DNNSA-SDP films (10-16 S/cm) treated with the solvent (BC) only. This suggests that acids weaker than sulfonic acid can be used to enhance the film conductivity after the treatment. H₃PO₄ is an attractive candidate for use in capacitor applications because it is inexpensive, less toxic or harmful than many organic acids, and non-oxidative.

TABLE 2
Electrical conductivity of PANi/DNNSA-SDP film before and
after treatment with various BC solutions of acids.

| | BEFORE | AFTER | |
|---|---|---|---|
| Film Type | (S/cm) | (S/cm) | Treatment Type |
| PANi/DNNSA-SDP | 19.0 | 146 | 5 wt % PTSA-BC |
| PANi/DNNSA-SDP | 20 | 124 | 5 wt % BA-BC |
| PANi/DNNSA-SDP | 15.9 | 72.7 | 5 wt % CSA-BC |
| PANi/DNNSA-SDP | 20 | 52 | 5 wt % PA-BC |
| PANi/DNNSA-SDP | 16.3 | 48.4 | 5 wt % H₃PO₄-BC |

### EXAMPLE 7

This example shows the effect on electrical conductivity of the time of contact between the acid/organic solvent solution and the film of polyaniline doped with dinonylnaphthalene sulfonic acid and sulfonyldiphenol (PANi/DNNSA-SDP) plus excess dinonylnaphthalene sulfonic acid (DNNSA).

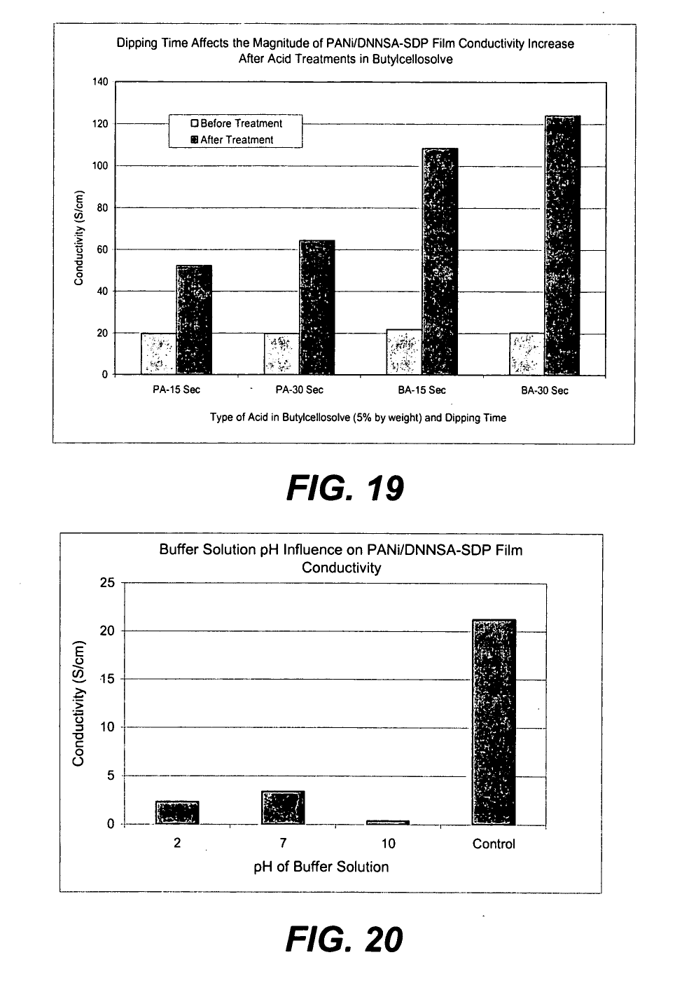

Films of PANi/DNNSA-SDP were contacted with solutions of 5% by weight phenylphosphonic acid (PA) or benzenesulfonic acid (BA) in butylcellosolve by dipping. It was found that the time that the film is in contact with the organic acid solution has an effect on the final conductivity. Results with PA and BA, using either 15 second or 30 second dips, are summarized in FIG. 19. Accordingly, it is preferred that the conductive polymer film is contacted with the second protonic acid in the organic solvent for a time sufficient to achieve the desired improvement in thermal stability and electrical properties.

### EXAMPLE 8

This example illustrates the effect of treating films of polyaniline doped with dinonyinaphthalene sulfonic acid and sulfonyldiphenol (PANi/DNNSA-SDP) plus excess dinonylnaphthalene sulfonic acid (DNNSA) with aqueous buffer solutions and with aqueous solutions of organic acids.

Treatment of PANi/DNNSA-SDP Films with Aqueous Buffer Solutions:

Aqueous buffer solutions were prepared at pH values of 2, 7, and 11. In each case, a PANi/DNNSA-SDP film was soaked in the buffer solutions for 30 minutes at 45° C. After soaking, no film shrinkage was observed, which suggested that no DNNSA was removed from the film. Given that neither DNNSA nor its salt is water-soluble, this result was not surprising. What was surprising, however, is that the contact caused a striking decrease in film conductivity. FIG. 20 shows the effect of pH of the buffer solution on the electrical conductivity of the PANi/DNNSA-SDP film. The treated films exhibit conductivities ranging from 0.4 to 3.4 S/cm, which is much smaller than that of the control (22 S/cm). Even an acidic aqueous buffer solution with pH of 2 caused a reduction in the film conductivity to 2.3 S/cm.

Treatment of PANi/DNNSA-SDP films with aqueous solutions of organic acids:

PANi/DNNSA-SDP films were treated as described above in Example 4 with 5% by wt. aqueous solutions of the following acids: p-toluenesulfonic acid (PTSA), dodecylbenzenesulfonic acid (DBSA), 4-sulfophthalic acid (4-SPHA), and poly(styrenesulfonic acid) (PSSA).

PSSA is a polymeric sulfonic acid whose repeating unit structure is similar to PTSA, in that it has a sulfonic acid group attached directly to a phenyl ring. DBSA is a small molecule sulfonic acid similar to PTSA except that it has a dodecyl (C12) group instead of a methyl substituent. The longer n-dodecyl group of DBSA makes the acid more hydrophobic than PTSA, so we expected that DBSA would interact favorably with DNNSA in PANi/DNNSA-SDP films to improve the film conductivity and thickness. 4-SPHA has two carboxylic acid groups in addition to its sulfonic acid group, so it is a more hydrophilic alternative.

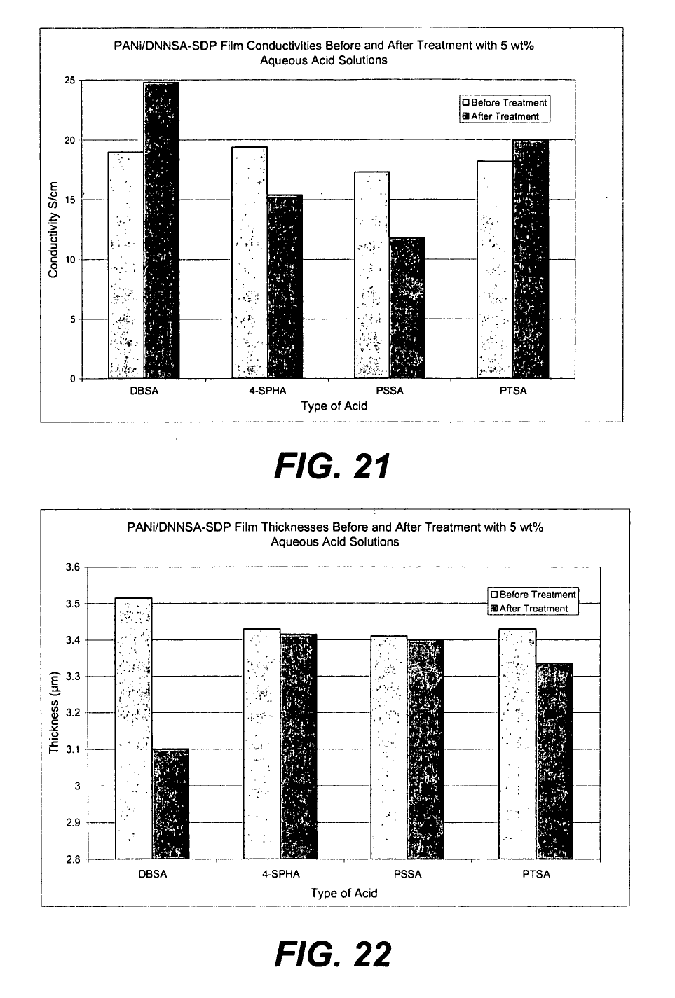

Films of PANi/DNNSA-SDP were cast on glass slides, and then one-half of each sample was soaked in the aqueous acid solution for 30 seconds, while the other half remained untreated. After drying, silver bars were printed on each half of the film samples so that film resistance and thicknesses could be determined. The change in electrical conductivity after each of the acid aqueous solution treatments is shown in FIG. 21. Treatment with either aqueous DBSA or aqueous PTSA slightly increased the film conductivity, but the increase was not significant compared to treatment with PTSA in butylcellosolve. Similarly, film thicknesses (shown in FIG. 22) were either unchanged or only slightly reduced. Unexpectedly, treatment with either aqueous 4-SPHA or aqueous PSSA slightly decreases the film conductivity.

### EXAMPLE 9

This example illustrates the treatment of conductive polymer films that were deposited as solid electrolytes on tantalum (Ta) anode capacitor bodies with solutions of acids in organic solvents.

Current state-of-the-art Ta-polymer solid electrolytic capacitors typically have an internal coating of conductive polymer-based electrolyte (the internal cathode) and an external coating of conductive polymer-based electrolyte (the external cathode). Some typical conductive polymers used in these capacitors are based on polyethylenedioxythiophene, polypyrrole, and/or polyaniline. The conductive polymer cathode can then be further coated with (1) a carbon layer and (2) a silver layer. The silver layer functions as the electrical contact. A particularly important electrical characteristic of solid Ta-polymer electrolytic capacitors is their low and ultra-low equivalent series resistance (ESR), which makes these capacitors useful in high frequency applications.

General Methods for on-Capacitor Experiments:

In all cases, 470-μF, 2.5-V solid Ta anode bodies that had been pre-coated with an internal conductive polymer electrolyte were used as substrates for the on-capacitor tests.

The general procedure was as follows:
1. Coat the anodes with polyaniline doped with dinonylnaphthalene sulfonic acid with or without added sulfonyldiphenol (PANi/DNNSA or PANi/DNNSA-SDP by dip-coating into one of the following solutions for 30 seconds:
PANi/DNNSA solution:
   Polyaniline 3.6%
   Dinonylnaphthalene sulfonic acid 21.4%
   Xylenes (mixed isomers) 44.4%
   Butylcellosolve 30.6%
PANi/DNNSA-SDP solution:
   Polyaniline 3.3%
   Dinonylnaphthalene sulfonic acid 19.7%
   4,4′-sulfonyldiphenol 2.6%
   Xylenes (mixed isomers) 41.1%
   Butylcellosolve 33.4%;
2. Air-dry the anodes for 30-minutes at room temperature;
3. Oven-dry the anodes at 150° C. for 30 minutes;
4. Cool the anodes to room temperature for a minimum of 30 minutes; and optionally
5. dip the anodes for 30 seconds into a “treatment solution”, usually either an organic solvent or a 5 wt % solution of an organic acid such as p-toluenesulfonic acid (PTSA) in an organic solvent.
(If step 5 is used, the treated anodes are air-dried for 10-30 minutes at room temperature and then oven-dried at 150° C. for 30 minutes for 30 minutes)
Further optional steps can include:
a. Repeat steps 1-7;
b. Dip the treated anodes for 30 seconds into a final “rinse” solution, usually an organic solvent such as xylenes;
c. Apply a carbon layer to the anodes by dipping them for 30 seconds into a carbon ink, air-drying for 10 minutes at room temperature, oven-drying at 100° C. for 30 minutes, and cooling to room temperature for a minimum of 30 minutes; and
d. Apply a silver layer to the anodes by dipping them for 30 seconds into a silver ink, air-drying for 30 minutes at room temperature, oven-drying at 150° C. for 30 minutes, and cooling to room temperature for a minimum of 30 minutes.

Without the treatment step (5) as described above, the coated Ta capacitors typically exhibited an equivalent series resistance (ESR) ranging from 18 to 25 mΩ, when coated with a 25 wt % solution of PANi/DNNSA-SDP. After an additional high temperature treatment at 260° C. for 15 seconds, which is intended to model solder reflow temperatures that capacitors often experience in use, the ESR typically increases further by more than 5 mΩ, which can disqualify a capacitor for some commercial applications.

The present method was found to improve the electrical properties of capacitors having a conductive polymer film cathode in that it reduced the absolute ESR and the ESR increase after thermal treatment intended to model solder reflow conditions (the Δ-ESR).

Treatment of Tantalum Capacitor Anodes Coated with PANi/DNNSA or PANi/DNNSA-SDP Electrolyte Films with Solvents with or without Organic Acids:

Tantalum capacitor anodes that were coated with conductive polymer films as described above were subjected to treatment as described in step 5 with solutions of acids in organic solvents as shown in Table 3.

TABLE 3
Summary of electrical results for treatment solutions evaluated
on 470-uF, 2.5-V solid Ta capacitors coated with PANi/DNNSA or
PANi/DNNSA-SDP as external electrolyte.

| | | | | | | | Electrical Results | |
|---|---|---|---|---|---|---|---|---|
| | | | | | | | After High Temperature | |
| | | | Electrical Results | | | | Thermal Stress | |
| | | | Before High Temperature Thermal | | | | Conditions (260° C. | |
| 470-μF @ 2.5-V Capacitors | | | Stress Conditions | | | | for 15 seconds) | |
| | | | | | Leakage | | | |
| Type of Coating | | | | | Current @ | | | |
| (Coated from solution | | | | | 2.5 V (μA) | Percentage | | |
| in organic solvent at | Treatment | # of | | Capacitance | (Short caps | of “Short” | ESR | Capacitance |
| stated % solids) | Solution | anodes | ESR (mΩ) | (μF) | excluded) | Capacitors | (mΩ) | (μF) |
| PANi/DNNSA | | | | | | | | |
| Coatings | | | | | | | | |
| 25% solids | 5% PTSA- | 37 | 23.5 ± 3.4 | 502 ± 33 | 925 ± 1428 | 8.1% | 39.6 ± 8.6 | 491 ± 7 |
| | nBuOH | | | | | | | |
| 25% solids | 5% PTSA- | 37 | 24.9 ± 4.4 | 511 ± 30 | 249 ± 552 | 13.5% | 46.2 ± 7.0 | 486 ± 11 |
| | BC | | | | | | | |
| 25% solids | (1) 10% | 37 | 28.6 ± 4.4 | 472 ± 9 | 149 ± 495 | 2.7% | 49.8 ± 9.5 | 485 ± 12 |
| | SDP-BC | | | | | | | |
| | (2) 5% | | | | | | | |
| | PTSA-BC | | | | | | | |
| PANi/DNNSA/SDP, | | | | | | | | |
| single coatings | | | | | | | | |
| 15% solids | NONE - | 111 | 23.9 ± 1.2 | 501 ± 16 | 442 ± 944 | 22.5% | 37.8 ± 6.4 | 452 ± 36 |
| | CONTROL | | | | | | | |
| 25% solids | NONE - | 857 | 23.5 ± 3.4 | 467 ± 75 | 240 ± 542 | 16.2% | 36.9 ± 10.0 | 440 ± 51 |
| | CONTROL | | | | | | | |
| 25% solids | 1:1 BC and | 37 | 22.9 ± 0.9 | 465 ± 24 | 187 ± 618 | 18.9% | 41.3 ± 3.4 | 467 ± 16 |
| | MeOH | | | | | | | |
| 25% solids | BC | 37 | 21.2 ± 0.8 | 495 ± 4 | 253 ± 520 | 18.9% | 28.6 ± 1.6 | 475 ± 6 |
| 25% solids | Xylenes | 37 | 22.0 ± 0.7 | 458 ± 8 | 59 ± 135 | 10.8% | 36.2 ± 5.7 | 465 ± 8 |
| 25% solids | 5% H3PO4- | 37 | 21.6 ± 1.2 | 524 ± 4 | 289 ± 709 | 8.1% | 36.2 ± 3.6 | 491 ± 94 |
| | BC | | | | | | | |
| 25% solids | 5% PTSA- | 74 | 20.6 ± 1.3 | 489 ± 11 | 156 ± 433 | 4.1% | 23.1 ± 1.4 | 456 ± 14 |
| | nBuOH | | | | | | | |
| 25% solids | 5% PTSA- | 172 | 20.6 ± 1.2 | 499 ± 15 | 182 ± 563 | 4.7% | 23.7 ± 1.6 | 466 ± 23 |
| | BC | | | | | | | |
| 25% solids | (a) 5% | 37 | 19.8 ± 1.5 | 533 ± 25 | 84 ± 173 | 10.8% | 23.8 ± 2.1 | 478 ± 13 |
| | PTSA-BC | | | | | | | |
| | (b) Xylenes | | | | | | | |
| 25% solids | 1% PTSA- | 37 | 20.3 ± 0.6 | 520 ± 4 | 350 ± 999 | 8.1% | 28.8 ± 1.1 | 472 ± 6 |
| | BC | | | | | | | |
| 25% solids | 0.05% | 37 | 22.2 ± 2.2 | 518 ± 4 | 132 ± 242 | 10.8% | 38.8 ± 3.8 | 470 ± 10 |
| | PTSA-BC | | | | | | | |
| 25% solids | 5% SPHA- | 37 | 23.6 ± 4.0 | 461 ± 9 | 101 ± 197 | 0.0% | 29.3 ± 6.0 | 455 ± 5 |
| | BC | | | | | | | |
| PANi/DNNSA/SDP, | | | | | | | | |
| multiple coatings | | | | | | | | |
| (1) 25% solids | (1) 5% | 91* | 22.5 ± 2.4 | 468 ± 28 | 267 ± 1046 | 3.3% | 25.9 ± 3.7 | 474 ± 19 |
| | PTSA-BC | | | | | | | |
| (2) 25% solids | (2) 5% | | | | | | | |
| | PTSA-BC | | | | | | | |
| (1) 25% solids | (1) 5% | 31* | 19.7 ± 0.9 | 447 ± 7 | 62 ± 146 | 0.0% | 23.8 ± 1.6 | 442 ± 5 |
| | PTSA-BC | | | | | | | |
| (2) 25% solids | (2) 5% | | | | | | | |
| | H3PO4-BC | | | | | | | |
| (1) 15% solids | (1) 5% | 29* | 21.2 ± 0.7 | 521 ± 5 | 154 ± 604 | 6.9% | 22.7 ± 0.9 | 455 ± 9 |
| | PTSA-BC | | | | | | | |
| (2) 15% solids | (2) 5% | | | | | | | |
| | PTSA-BC | | | | | | | |
| (1) 15% solids, no | (1) none | 37 | 21.8 ± 1.0 | 528 ± 19 | 558 ± 1330 | 13.5% | 24.7 ± 1.3 | 459 ± 181 |
| cure | | | | | | | | |
| (2) 15% solids | (2) 5% | | | | | | | |
| | PTSA-BC | | | | | | | |
| (1) 15% solids | (1) none | 17 | 22.3 ± 0.6 | 511 ± 6 | 234 ± 361 | 0.0% | 24.4 ± 0.7 | 459 ± 5 |
| (2) 15% solids | (2) 5% | | | | | | | |
| | PTSA-BC | | | | | | | |
| (1) 15% solids | (1) none | 18 | 23.0 ± 0.7 | 508 ± 3 | 140 ± 229 | 16.7% | 25.5 ± 0.9 | 462 ± 9 |
| (2) 15% solids | (2a) 5% | | | | | | | |
| | PTSA-BC | | | | | | | |
| | (2b) | | | | | | | |
| | Xylenes | | | | | | | |

| | | | Electrical Results | | |
|---|---|---|---|---|---|
| | | | After High Temperature | | |
| | | | Thermal Stress | | |
| | | | Conditions (260° C. | | |
| 470-μF @ 2.5-V Capacitors | | | for 15 seconds) | | |
| | | | Leakage | | |
| Type of Coating | | | Current @ | | |
| (Coated from solution | | | 2.5 V (μA) | Percentage | |
| in organic solvent at | Treatment | # of | (Short caps | of “Short” | ΔESR |
| stated % solids) | Solution | anodes | excluded) | Capacitors | (mΩ) |
| PANi/DNNSA | | | | | |
| Coatings | | | | | |
| 25% solids | 5% PTSA- | 37 | 283 ± 497 | 13.5% | 16.1 ± 5.3 |
| | nBuOH | | | | |
| 25% solids | 5% PTSA- | 37 | 98 ± 274 | 13.5% | 21.3 ± 3.4 |
| | BC | | | | |
| 25% solids | (1) 10% | 37 | 173 ± 623 | 0.0% | 21.2 ± 5.6 |
| | SDP-BC | | | | |
| | (2) 5% | | | | |
| | PTSA-BC | | | | |
| PANi/DNNSA/SDP, | | | | | |
| single coatings | | | | | |
| 15% solids | NONE - | 111 | 201 ± 480 | 27.9% | 13.9 ± 6.1 |
| | CONTROL | | | | |
| 25% solids | NONE - | 857 | 185 ± 661 | 19.3% | 13.4 ± 8.2 |
| | CONTROL | | | | |
| 25% solids | 1:1 BC and | 37 | 57 ± 214 | 21.6% | 18 ± 3 |
| | MeOH | | | | |
| 25% solids | BC | 37 | 72 ± 224 | 21.6% | 7.4 ± 1.2 |
| 25% solids | Xylenes | 37 | 229 ± 738 | 8.1% | 14 ± 6 |
| 25% solids | 5% H3PO4- | 37 | 183 ± 559 | 8.1% | 15 ± 3 |
| | BC | | | | |
| 25% solids | 5% PTSA- | 74 | 74 ± 189 | 5.4% | 2.6 ± 0.3 |
| | nBuOH | | | | |
| 25% solids | 5% PTSA- | 172 | 110 ± 434 | 5.8% | 3.1 ± 0.7 |
| | BC | | | | |
| 25% solids | (a) 5% | 37 | 42 ± 86 | 10.8% | 4.0 ± 0.8 |
| | PTSA-BC | | | | |
| | (b) Xylenes | | | | |
| 25% solids | 1% PTSA- | 37 | 290 ± 828 | 8.1% | 8.5 ± 1.1 |
| | BC | | | | |
| 25% solids | 0.05% | 37 | 96 ± 261 | 27.0% | 16.6 ± 3.6 |
| | PTSA-BC | | | | |
| 25% solids | 5% SPHA- | 37 | 57 ± 122 | 0.0% | 5.7 ± 2.1 |
| | BC | | | | |
| PANi/DNNSA/SDP, | | | | | |
| multiple coatings | | | | | |
| (1) 25% solids | (1) 5% | 91* | 235 ± 1118 | 3.3% | 3.3 ± 1.6 |
| | PTSA-BC | | | | |
| (2) 25% solids | (2) 5% | | | | |
| | PTSA-BC | | | | |
| (1) 25% solids | (1) 5% | 31* | 31 ± 79 | 0.0% | 4.0 ± 1.8 |
| | PTSA-BC | | | | |
| (2) 25% solids | (2) 5% | | | | |
| | H3PO4-BC | | | | |
| (1) 15% solids | (1) 5% | 29* | 44 ± 157 | 13.8% | 1.6 ± 0.2 |
| | PTSA-BC | | | | |
| (2) 15% solids | (2) 5% | | | | |
| | PTSA-BC | | | | |
| (1) 15% solids, no | (1) none | 37 | 428 ± 1109 | 18.9% | 2.9 ± 0.5 |
| cure | | | | | |
| (2) 15% solids | (2) 5% | | | | |
| | PTSA-BC | | | | |
| (1) 15% solids | (1) none | 17 | 75 ± 145 | 0.0% | 2.0 ± 0.2 |
| (2) 15% solids | (2) 5% | | | | |
| | PTSA-BC | | | | |
| (1) 15% solids | (1) none | 18 | 83 ± 170 | 22.2% | 2.5 ± 0.2 |
| (2) 15% solids | (2a) 5% | | | | |
| | PTSA-BC | | | | |
| | (2b) | | | | |
| | Xylenes | | | | |

PTSA = p-toluenesulfonic acid,
4-SPHA = 4-sulfophthalic acid,
H₃PO₄ = phosphoric acid,
SDP = sulfonyldiphenol,
BC = butylcellosolve,
nBuOH = n-butanol,
MeOH = methanol.

Of the conditions tested, the treatment giving the best results was the use of a 5 wt % solution of PTSA as treatment on a PANi/DNNSA-SDP coating. The results of that treatment can be summarized as follows:

ΔESR, which is the ESR increase after thermal stress at 260° C. for 15 seconds, was reduced to 2 to 3 mΩ.

The percentage of “short” capacitors is reduced to <10%. In the context of the experiments described herein, a “short” capacitor is one in which the leakage current exceeds 11,500 μA when tested at the capacitor's rated voltage.

It is believed that multiple PANi/DNNSA-SDP film coatings, each with a 5 wt % PTSA treatment, may improve the percentage of “short” capacitors, but has minimal, if any, effect on ESR or ΔESR.

Initial ESR ranged from 19 to 22 mΩ, which is believed to be sufficient for commercial applications.

Capacitance remained close to the product rating of 470 μF.

It was shown that at least two different organic solvents were successfully used for the PTSA treatment solution, and it is expected that other alcohols and polar solvents would be suitable as well.

The preferred weight percent of the organic acid in the organic solvent treatment solution should be at least 0.1% by weight, and at least 1%, or at least 5% are more preferred. Lower concentrations are less efficient at ion exchange given a fixed dipping time of 30 seconds. It is believed that higher concentrations push the equilibrium favorably toward more PTSA in the films.

Other organic and inorganic acids which are more thermally stable than DNNSA and which are soluble in organic solvents that also dissolve DNNSA can be substitutes for the PTSA. For example, 4-sulfophthalic acid (4-SPHA) and phosphoric acid (H₃PO₄) are effective as alternatives and lead to higher film thermal stability and lower ESR.

### EXAMPLE 10

This example illustrates the thermal stability under prolonged heating of treated films of polyaniline doped with dinonylnaphthalene sulfonic acid and sulfonyldiphenol (PANi/DNNSA-SDP) applied as external cathodes on tantalum (Ta) capacitor bodies.

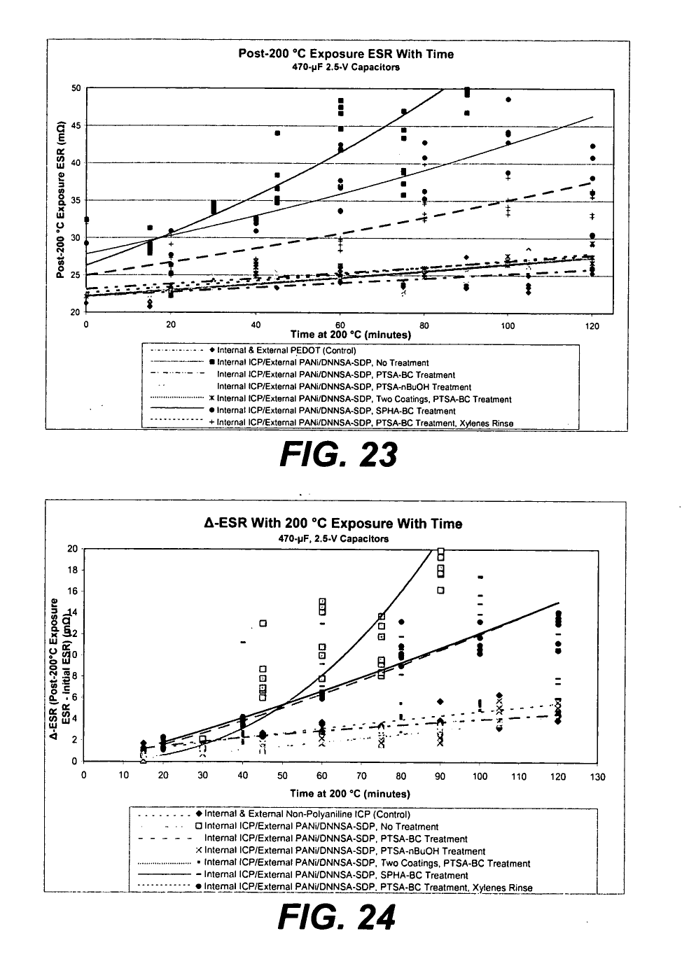

To demonstrate the improved thermal stability of the PANi/DNNSA-SDP film electrode when treated with a 5 wt % solution of p-toluenesulfonic acid (PTSA) in organic solvent, an experiment was carried out in which coated and treated Ta capacitor bodies were placed in a box oven at 200° C. for varying lengths of time. A comparison of the equivalent series resistance (ESR) and change in ESR (ΔESR) over time at 200° C. for the four types of anodes tested in this experiment is shown in FIG. 23 and FIG. 24, respectively. The ΔESR is the difference between the final ESR value (after the 200° C. exposure) and the initial ESR.

All references cited in this specification, including without limitation all papers, publications, patents, patent applications, presentations, texts, reports, manuscripts, brochures, books, internet postings, journal articles, periodicals, and the like, are hereby incorporated by reference into this specification in their entireties. The discussion of the references herein is intended merely to summarize the assertions made by their authors and no admission is made that any reference constitutes prior art. Applicants reserve the right to challenge the accuracy and pertinency of the cited references.

In view of the above, it will be seen that the several advantages of the invention are achieved and other advantageous results obtained.

As various changes could be made in the above methods and compositions by those of ordinary skill in the art without departing from the scope of the invention, it is intended that all matter contained in the above description and shown in the accompanying drawings shall be interpreted as illustrative and not in a limiting sense. In addition it should be understood that aspects of the various embodiments may be interchanged either in whole or in part.

What is claimed is:

1. A method of making an electrically conductive polymer film having improved thermal stability, the method comprising:
providing a film of an electrically conductive polymer having as a dopant a first protonic acid that is selected to solubilize the doped conductive polymer in a first organic solvent; and
contacting the film with a mixture of a second organic solvent and a second protonic acid.

2. The method according to claim 1, wherein the step of providing a film of an electrically conductive polymer comprises:
applying to a surface a mixture of a first organic solvent and an electrically conductive polymer having as a dopant a first protonic acid that is selected to solubilize the doped conductive polymer in the first organic solvent; and
removing the first organic solvent and forming a film of the doped electrically conductive polymer.

3. The method according to claim 1, wherein the first protonic acid dopant comprises dodecylbenzenesulfonic acid, camphorsulfonic acid or dinonylnaphthalenesulfonic acid.

4. The method according to claim 1, wherein the second protonic acid comprises a compound having the formula:
R₁HSO₃
where R₁ is a substituted or unsubstituted organic radical.

5. The method according to claim 1, wherein the second protonic acid dopant comprises a compound having the formula: 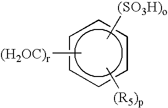
wherein:
o is 1, 2 or 3;
r and p are the same or are different and are 0, 1 or 2; and
R₅ is alkyl, fluoro, or alkyl substituted with one or more fluoro or cyano groups.

6. The method according to claim 3, wherein the second protonic acid dopant comprises p-toluenesulfonic acid.

7. The method according to claim 1, wherein the step of providing a film of an electrically conductive polymer further comprises providing a film that contains 4,4′-sulfonyldiphenol.

8. The method according to claim 1, wherein the first organic solvent has a dielectric constant lower than about 10.

9. The method according to claim 1, wherein the first organic solvent comprises a mixture of xylenes and butylcellosolve.

10. The method according to claim 1, wherein the second organic solvent comprises a liquid having a dielectric constant that is higher than the dielectric constant of the first organic solvent.

11. The method according to claim 1, wherein the second organic solvent comprises one or both of n-butanol and butylcellosolve.

12. The method according to claim 1, wherein the mixture of the second organic solvent and the second protonic acid contains the second protonic acid in an amount of from about 1% to about 10% by weight.

13. The method according to claim 1, wherein the mixture of the second organic solvent and the second protonic acid contains the second protonic acid in an amount of from about 3% to about 7% by weight.

14. The method according to claim 1, wherein the step of contacting the film with a mixture of a second organic solvent and a second protonic acid comprises dipping the film in the mixture comprising the second organic solvent for a period of time sufficient to extract an amount of the first protonic acid to result in an increase in the thermal stability of the conductive polymer film.

15. The method according to claim 13, wherein the step of contacting the film with a mixture of a second organic solvent and a second protonic acid comprises dipping the film in the mixture comprising the second organic solvent for a period of time sufficient to extract at least about 10% by weight of the first protonic acid.

16. The method according to claim 1, wherein the conductive polymer comprises a polymer formed from polymerized monomer units of substituted or unsubstituted aniline, pyrrole, or thiophene.

17. The method according to claim 1, wherein the conductive polymer comprises polyaniline.

18. The method according to claim 6, wherein the conductive polymer comprises polyaniline.

19. The method according to claim 2, wherein the step of applying to a surface comprises applying to a surface comprising a dielectric metal oxide or a surface comprising one or more layers of a conductive polymer formed over a dielectric metal oxide.

20. A method of using an electrically conductive polymer film having improved thermal properties as a solid electrolyte in a valve-metal capacitor, the method comprising:
providing a capacitor body comprising an anode of the valve-metal, a dielectric metal oxide layer, and an electrically conductive polymer film cathode having a thermal stability and which comprises a conductive polymer having as a dopant a sufficient amount of a first protonic acid that is selected to solubilize the polyaniline in a first organic solvent; and
contacting the film with a second organic solvent containing a second protonic acid, thereby improving the thermal stability of the conductive polymer film.

21. The method according to claim 20, wherein the first protonic acid is more soluble in the second organic solvent than the electrically conductive polymer.

22. The method according to claim 20, wherein the step of providing a film of an electrically conductive polymer comprises:
applying over the dielectric metal oxide layer a mixture of the first organic solvent and the electrically conductive polymer having as a dopant a first protonic acid that is selected to solubilize the conductive polymer in the first organic solvent; and
removing the first organic solvent and forming a film of the doped electrically conductive polymer on the dielectric metal oxide layer.

23. The method according to claim 22, wherein the first protonic acid dopant comprises dinonylnaphthalene sulfonic acid and the second protonic acid dopant comprises p-toluenesulfonic acid.

24. The method according to claim 22, wherein the first organic solvent comprises a mixture of xylenes and butylcellosolve and the second organic solvent comprises n-butanol, butylcellosolve, or a mixture thereof.

25. A method of making an electrically conductive polymer film having improved thermal stability, the method comprising:
providing a film of an electrically conductive polymer having as a dopant a first protonic acid that is selected to solubilize the doped conductive polymer in a first organic solvent; and
contacting the film with a mixture of a second organic solvent and a second protonic acid,
wherein the concentration of the second protonic acid in the mixture with the second organic solvent and the time of contacting are selected to provide an increase in equivalent series resistance (ΔESR) of less than about 5 mΩ when the film is subjected to a temperature of 260° C. for 15 seconds.
